(19) United States
(12) Patent Application Publication
(10) Pub. No.: US 2024/0029950 A1
(43) Pub. Date: Jan. 25, 2024

(54) TRANSFORMER

(71) Applicant: TOKYO KEIKI INC., Tokyo (JP)

(72) Inventor: Taiki Kawasaki, Tokyo (JP)

(21) Appl. No.: 18/025,224

(22) PCT Filed: Oct. 13, 2021
(86) PCT No.: PCT/JP2021/037939

§ 371 Date: Mar. 8, 2023

(30) Foreign Application Priority Data
Oct. 20, 2020 (JP) 2020-176183

(51) Int. Cl. H01F 30/16; H01F 27/26; H01F 27/28; H01F 30/10

(52) U.S. Cl. CPC H01F 30/16; H01F 27/266; H01F 27/2852; H01F 30/10

(57) ABSTRACT

A transformer comprises an annular core which is a magnetic material formed in a ring shape, a primary coil L1 configured with plate-shaped conductors wound around the annular core, and a secondary coil L2 configured with plate-shaped conductors wound around the annular core.

### TECHNICAL FIELD

This invention relates to a transformer.

### BACKGROUND ART

Transformers comprising a magnetic material for the core and primary and secondary coils made by winding wires such as coaxial cables around the magnetic material are commonly used.

As related technology, a transformer is known which comprises a core, a primary coil formed in such a way that the coil goes through the core and having a high electrical potential, a secondary coil formed inside the primary coil and having a low electrical potential, a primary coil bobbin comprising four bars for holding the primary coil, and a side plate on which the primary coil bobbin is fixed and air duct are formed (see, for example, Patent Document 1).

### CITATION LIST

### Patent Document

Patent document 1: JP2020-136364

### DISCLOSURE OF THE INVENTION

### Problems to be Solved by the Invention

When a large power of maximum 2 KW, for example, is input to a transformer with primary and secondary coils configured with coaxial cables, a problem occurs, that is, heat that makes transformers impractical is generated by conductor loss of the coaxial cable's inner conductors.

The purpose of the present invention is to solve the above-mentioned problems and to provide a technology that can further reduce conductor loss in a transformer.

### Means for Solving the Problems

In order to solve the above-mentioned problems, the transformer of the present embodiment comprises an annular core which is a magnetic material formed in a ring shape, a primary coil configured with plate-shaped conductors wound around the annular core, and a secondary coil configured with plate-shaped conductors wound around the annular core.

### Advantageous Effects of the Invention

According to the present invention, conductor loss in transformers can be further reduced.

### BRIEF DESCRIPTION OF THE DRAWINGS

FIG. 1 is a perspective view showing the transformer of the present embodiment viewed from above.

FIG. 2 is an exploded perspective view showing the transformer of the present embodiment viewed from above.

FIG. 3 is an exploded perspective view showing the transformer of the present embodiment viewed from below.

FIG. 4 is a plan view showing the first lower board.

FIG. 5 is a bottom view showing the first lower board.

FIG. 6 is a plan view showing the second lower board.

FIG. 7 is a bottom view showing the second lower board.

FIG. 8 is an enlarged view showing the key area of the first connecting conductor.

FIG. 9 is an enlarged view showing the key area of the second connecting conductor.

FIG. 10 is a plan view showing the second upper board.

FIG. 11 is a plan view showing the first upper board.

FIG. 12 is an illustration showing the arrangement of conductors.

FIG. 13 is an illustration showing the connection configuration in the primary coil.

FIG. 14 is an illustration showing the connection configuration in the secondary coil.

FIG. 15 is an equivalent circuit diagram showing the transformer of the present embodiment.

### BEST MODE FOR CARRYING OUT THE INVENTION

In the following, the embodiment of the invention is described with reference to the drawings.

### (General Configuration)

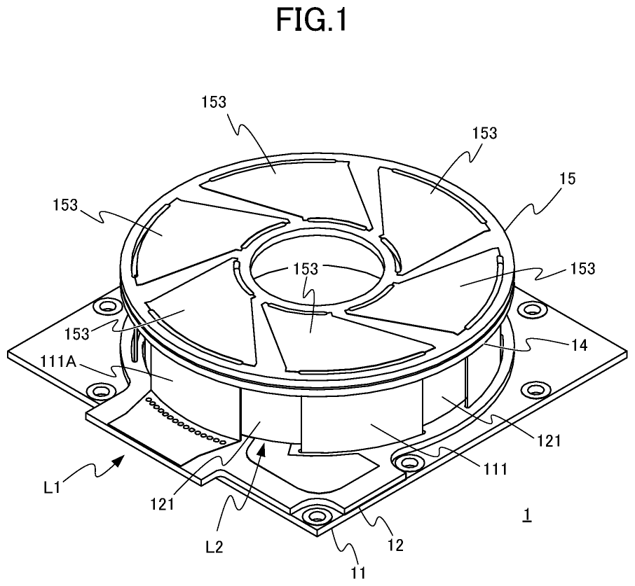

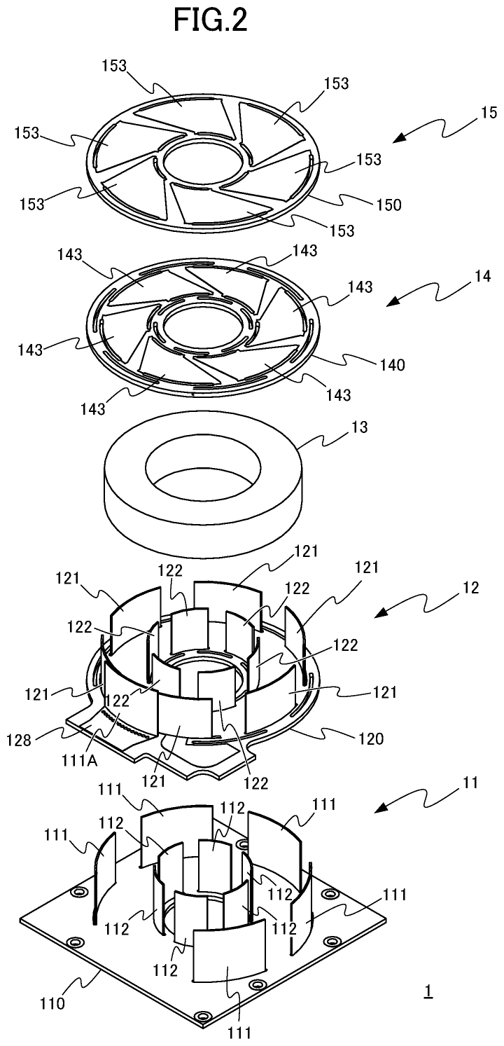

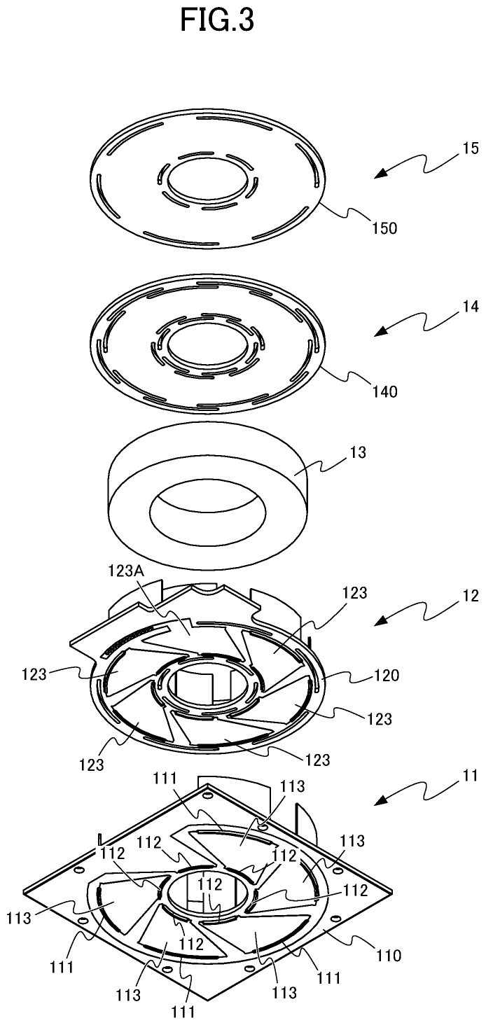

The following is a description of the general configuration of the transformer according to the present embodiment. FIG. 1 is a perspective view of the transformer viewed from above, and FIGS. 2 and 3 are exploded perspective views of the transformer viewed from above and below, respectively.

As shown in FIGS. 1-3, the transformer 1 of the embodiment comprises a first lower board 11, a second lower board 12, an annular core 13, a second upper board 14, and a first upper board 15. The first lower board 11, a portion of the second lower board 12, and the first upper board 15 constitute the primary coil L1, in such a way as to wind around the annular core 13 along its circumferential direction, which is made by forming a magnetic material into a circular ring shape, like a ferrite core, for example. The second lower board 12 and the second upper board 14 constitute the secondary coil L2 in such a way as to wind around the annular core 13 along its circumferential direction. The transformer 1 is configured so that the primary coil L1 covers the secondary coil L2, that is, the secondary coil L2 is positioned closer to the annular core 13 than the primary coil L1. In the present embodiment, the vertical direction is the direction perpendicular to the radial direction originating from the circle center O (see FIG. 12) of the annular core 13 formed in a circular ring shape, that is, the direction that penetrates the hole of the annular core 13. The annular core 13 may be configured in any shape so long as it is a ring-like shape; for example, it may be configured in a frame shape.

### (The First Lower Board)

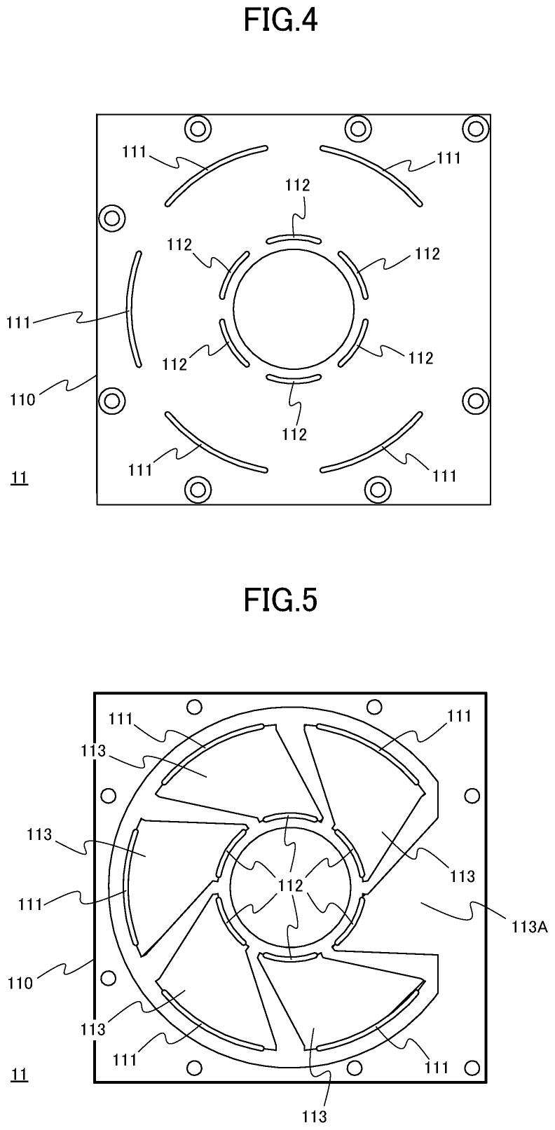

The configuration of the first lower board is described below. FIGS. 4 and 5 show the plan view and bottom view, respectively, of the first lower board.

As shown in FIGS. 4 and 5, the first lower board 11 includes a substrate 110 made of insulator formed in a flat plate shape, five first outer conductors 111, six first inner conductors 112, five first lower conductors 113 that electrically connect the first outer conductors 111 and the first inner conductors 112, and a connection terminal 113A for connecting the transformer 1 to external equipment. The first outer conductors 111 and the first inner conductor 112 are plate-shaped conductors of a predetermined height and paralleling along the outer wall (radially outer surface) and inner wall (radially inner surface) of the annular core 13 in the circumferential direction for a predetermined length, respectively, and are formed as copper plates in the present embodiment.

Each of the six first inner conductors 112 is disposed equally spaced apart from each other in the circumferential direction of the annular core 13. Each of the five first outer conductors 111 is disposed corresponding to five of the six first inner conductors 112 and is displaced clockwise (counterclockwise in FIG. 5) when viewed from above in the circumferential direction from the corresponding first inner conductor 112.

The first lower conductors 113 and the connection terminal 113A are conductor patterns printed on the bottom surface of the substrate 110 and are formed in copper foils in the present embodiment. The first outer conductor 111 and the first inner conductor 112 penetrate the substrate 110 from top downward so that they protrude from the top surface of the substrate 110 upward with their lower ends protruding slightly from the bottom surface of the substrate 110 downward and are supported by the substrate 110. The first lower conductors 113 are configured to connect the corresponding first outer conductors 111 and first inner conductors 112, and when soldered to the first lower conductors 113, the first outer conductors 111 and first inner conductors 112 are electrically connected and fastened to the substrate 110. Of the six first inner conductors 112, a first inner conductor 112 which has no corresponding first outer conductor 111 is soldered to the connection terminal 113A.

### (The Second Lower Board)

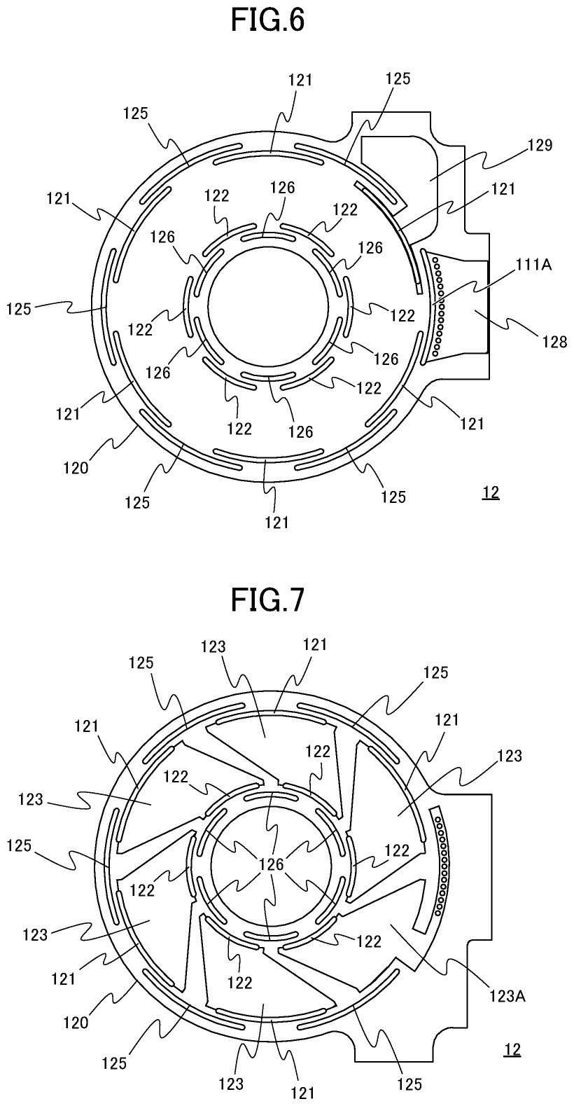

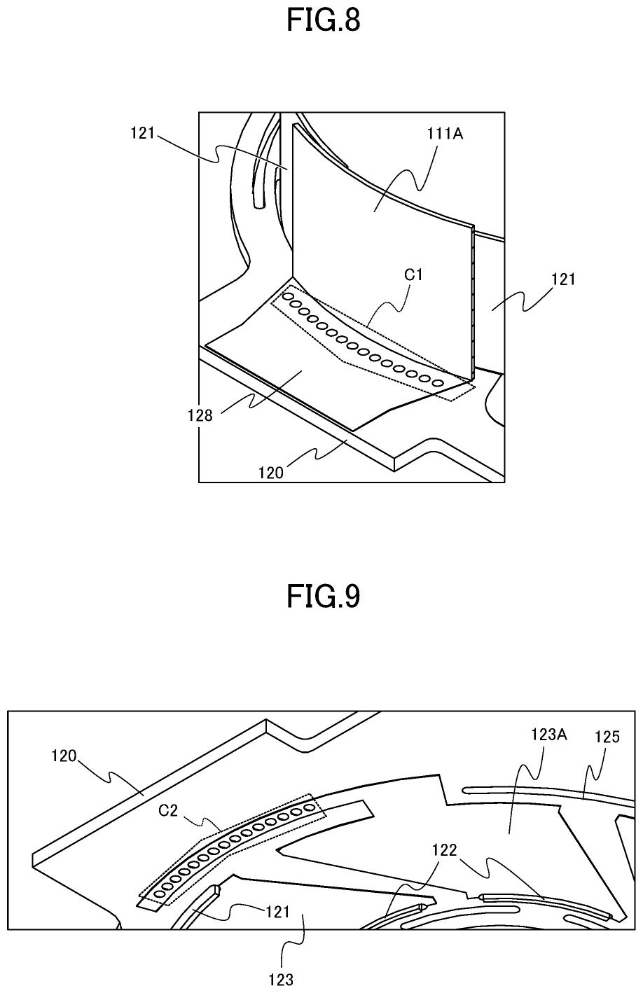

FIGS. 6 and 7 show the plan view and bottom view, respectively, of the second lower board. FIGS. 8 and 9 are enlarged views of the key area showing the first and second connecting conductors, respectively.

As shown in FIGS. 6 and 7, the second lower board 12 includes a substrate 120 made of insulator formed in a flat plate shape, six second outer conductors 121, six second inner conductors 122, one first outer conductor 111A, five second lower conductors 123 that electrically connect the second outer conductors 121 and the second inner conductors 122, a first connecting conductor 128, a second connecting conductor 123A, and a connection terminal 129 for connecting the transformer 1 to external equipment. The second outer conductor 121 and the second inner conductor 122 are plate-shaped conductors of a predetermined height and paralleling along the outer wall (radially outer surface) and inner wall (radially inner surface) of the annular core 13 in the circumferential direction for a predetermined length, respectively, and are formed as copper plates in the present embodiment.

Each of the six second outer conductors 121 and each of the six second inner conductors 122 are disposed equally spaced apart from each other in the circumferential direction of the annular core 13. Each of the six second outer conductors 121 is disposed corresponding to the six second inner conductors 122 and is displaced clockwise (counterclockwise in FIG. 7) when viewed from above in the circumferential direction from the corresponding second inner conductor 122.

The second lower conductors 123 and the second connecting conductor 123A are conductor patterns printed on the bottom surface of the substrate 120, the first connecting conductor 128 and the connection terminal 129 are conductor patterns printed on the top surface of the substrate 120, and all of these formed as copper foils in the present embodiment. The second outer conductor 121 and the second inner conductor 122 penetrate the substrate 120 from top downward so that they protrude from the top surface of the substrate 120 upward with their lower ends protruding slightly from the bottom surface of the substrate 120 downward and are supported by the substrate 120. The second lower conductors 123 are configured to connect the corresponding second outer conductors 121 and second inner conductors 122, and when soldered to the second lower conductors 123, the second outer conductors 121 and second inner conductors 122 are electrically connected and fastened to the substrate 120.

One of the six second outer conductors 121 is supported on the substrate 120 without penetration and is not electrically connected to the corresponding second inner conductor 122 in the unassembled state, where the second outer conductors 121 are not assembled with the second upper board 14. The second outer conductor 121 which is not connected to a second inner conductor 122 when in the unassembled state, is electrically connected by soldering to the connection terminal 129 formed on the top surface of the substrate 120. The second inner conductor 122 which is not connected to a second outer conductor 121 when in the unassembled state, is electrically connected by soldering to the second connecting conductor 123A.

The first outer conductor 111A is electrically connected to the first connecting conductor 128 by soldering and is supported on the substrate 120 so as to straddle the second outer conductor 121 having no connection with a second inner conductor 122 and the second outer conductor 121 disposed at the position clockwise in the circumferential direction relative to the said second outer conductor 121. In the following description, when the first outer conductor 111A needs not be specifically distinguished from the first outer conductors 111, the reference of the first outer conductors 111 collectively includes the first outer conductor 111A.

On the substrate 120, five first outer insertion slits 125 that penetrate vertically through the radially outer region with respect to the second outer conductors 121 straddling two circumferentially adjacent second outer conductors 121 are disposed, and six first inner insertion slits 126 that penetrate vertically through the radially inner region with respect to the second inner conductors 122 straddling two circumferentially adjacent second inner conductors 122 are disposed, similar to the first outer conductor 111A. The first lower board 11 and the second lower board 12 are assembled by inserting the first outer conductors 111 and the first inner conductors 112 of the first lower board 11 into the above first outer insertion slits 125 and first inner insertion slits 126 from below, wherein the second outer conductors 121 and the second inner conductors 122 are located between the first outer conductors 111, 111A and the first inner conductors 112.

As shown in FIG. 8, the first connecting conductor 128 has a connecting portion C1, and as shown in FIG. 9, the second connecting conductor 123A extends outward in the radial direction and has a connecting portion C2 corresponding to the connecting portion C1 at a portion further extended in the circumferentially clockwise direction (counterclockwise direction in FIG. 7), wherein the ends of the primary coil L1 and the secondary coil L2 are electrically connected by the vias connecting the connecting portions C1 and C2.

### (The Second Upper Board)

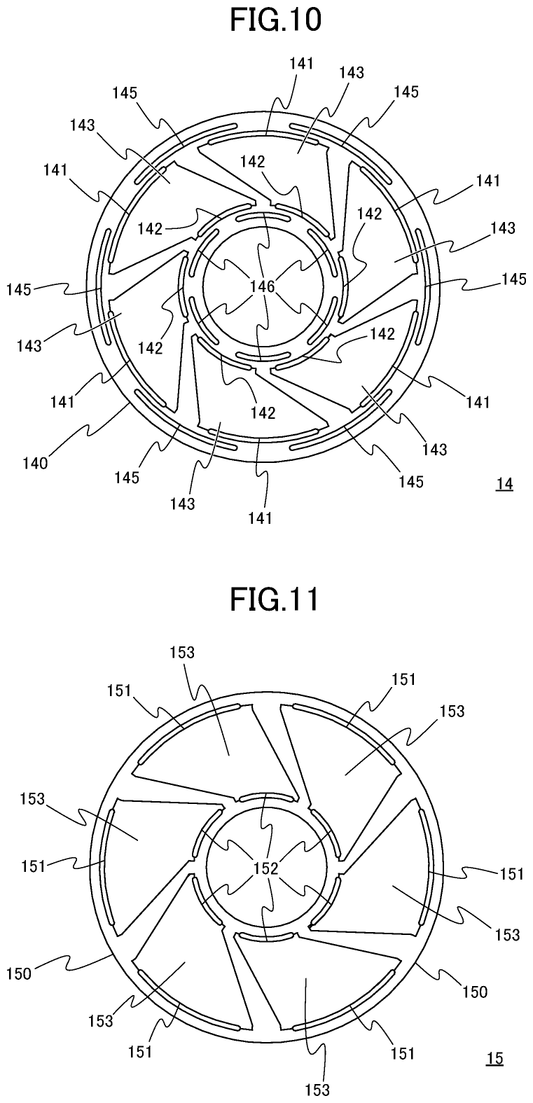

The configuration of the second upper board is described below. FIG. 10 is a plan view of the second upper board.

As shown in FIG. 10, the second upper board 14 includes a substrate 140 made of insulator formed in a flat plate shape and six second upper conductors 143 that electrically connect the second outer conductors 121 and the second inner conductors 122. The second upper conductors 143 are conductor patterns printed on the top surface of the substrate 140 and are formed as copper foils in the present embodiment. The second upper conductors 143 electrically connect each of the six second inner conductors 122 to a second outer conductor 121 adjacent counterclockwise in the circumferential direction viewed from above relative to the second outer conductor 121 connected by a second lower conductor 123.

The substrate 140 includes six second outer insertion slits 141 arranged circumferentially spaced apart from each other that penetrate vertically and match the second outer conductors 121, six second inner insertion slits 142 arranged circumferentially spaced apart from each other that penetrate vertically and match the second inner conductors 122, six first outer insertion slits 145 arranged circumferentially spaced apart from each other that penetrate vertically and match the first outer conductors 111 and 111A and six first inner insertion slits 146 arranged circumferentially spaced apart from each other that penetrate vertically and match the first inner conductors 112.

The second lower board 12 and the second upper board 14 are assembled by inserting the second outer conductors 121, the second inner conductors 122, and the first outer conductor 111A on the second lower board 12 into the second outer insertion slits 141, the second inner insertion slits 142, and one of the first outer insertion slits 145 from below. At this time, the annular core 13 is placed between the second lower board 12 and the second upper board 14, while being sandwiched in the radial direction between the second outer conductor 121 and the second inner conductor 122, and the upper ends of the second outer conductors 121 and the second inner conductors 122 protrude slightly upward from the second outer insertion slits 141 and the second inner insertion slits 142. Upper electrical connections between the second outer conductors 121 and the second inner conductors 122 are made when each of the second outer conductors 121 and the second inner conductors 122 protruding slightly upward are soldered to the second upper conductors 143.

When the second lower board 12 and the second upper board 14 are assembled, the first lower board 11 and the second upper board 14 are further assembled by inserting the first outer conductors 111 and the first inner conductors 112 on the first lower board 11 assembled with the second lower board 12 into the first outer insertion slits 145 and the first inner insertion slits 146 from below.

### (The First Upper Board)

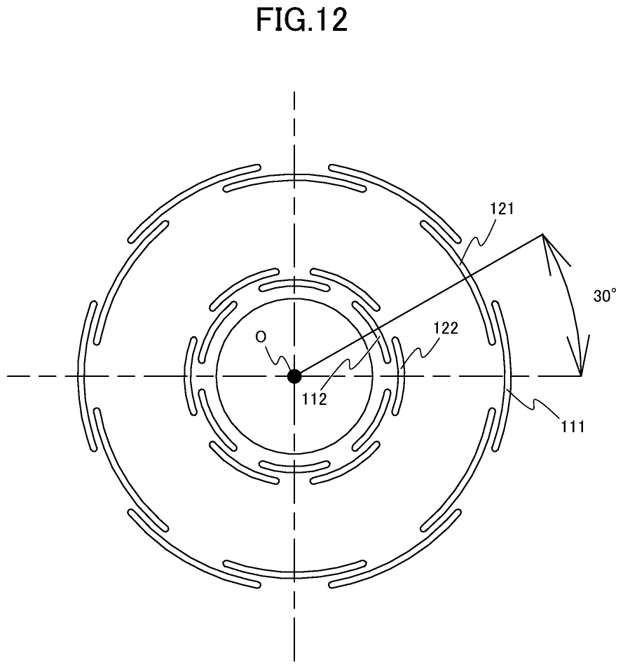

The configuration of the first upper board is described below. FIG. 11 is a plan view of the first upper board.

As shown in FIG. 11, the first upper board 15 includes a substrate 150 made of insulator formed in a flat plate shape and six first upper conductors 153 that electrically connect the first outer conductors 111 and the first inner conductors 112. The first upper conductors 153 are conductor patterns printed on the top surface of the substrate 150 and are formed as copper foils in the present embodiment. The first upper conductors 153 electrically connect each of the six first inner conductors 112 to a first outer conductor 111 adjacent counterclockwise in the circumferential direction viewed from above relative to the first outer conductor 111 connected by a first lower conductor 113.

On the substrate 150 are provided six first outer insertion slits 151 arranged circumferentially spaced apart from each other that penetrate vertically and match the first outer conductors 111 and 111A and six first inner insertion slits 152 arranged circumferentially spaced apart from each other that penetrate vertically and match the first inner conductors 112. The first lower board 11, the second lower board 12, the second upper board 14 and the first upper board 15 are assembled by inserting the first outer conductors 111 and the first inner conductors 112 on the first lower board 11 assembled with the second lower board 12 and the second upper board 14 into the first outer insertion slits 151 and the first inner insertion slits 152 from below, wherein the first outer conductor 111A on the second lower board 12 is inserted into a first outer insertion slit 151 from below.

In the state of all boards having been assembled together, the first outer conductors 111, 111A and the first inner conductors 112 protrude slightly upward from the first outer insertion slits 151 and the first inner insertion slits 152, and upper electrical connections between the first outer conductors 111, 111A and the first inner conductors 112 are made when each of the first outer conductors 111 and the first inner conductors 112 protruding slightly upward are soldered to the first upper conductors 153.

Thus, configuring the primary coil L1 and the secondary coil L2 with plate-shaped conductors can reduce conductor loss due to skin effect and improve the heat dissipation properties compared to configuring coils using coaxial cables. Furthermore, by using conductor patterns formed on the substrates for the upper and lower conductors among the conductors constituting the primary coil L1 and secondary coil L2, the primary coil L1 and secondary coil L2 can be produced at a lower cost compared to the case where plate-shaped conductors are used for all the components of the primary coil L1 and secondary coil L2.

### (The Configuration of Primary and Secondary Coils)

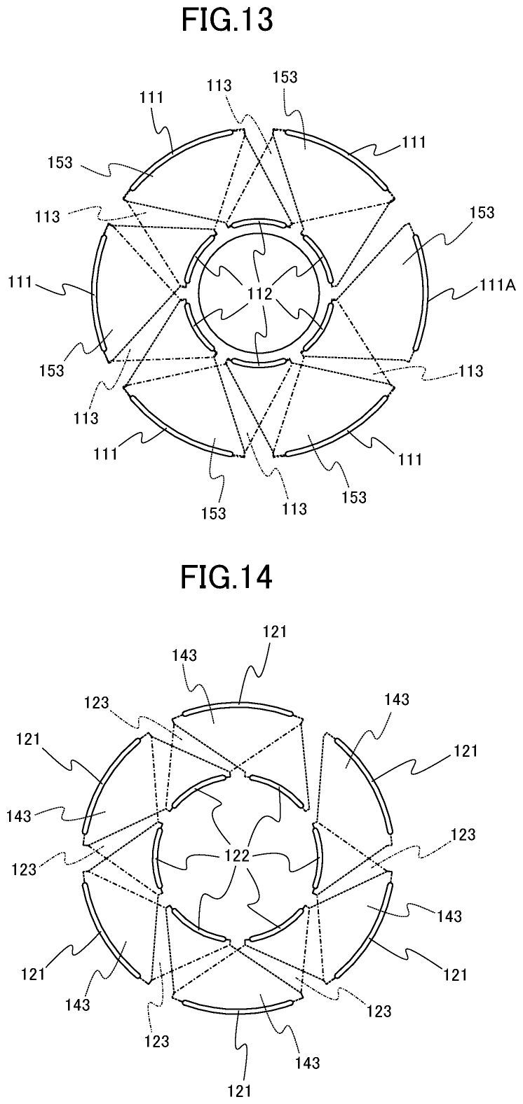

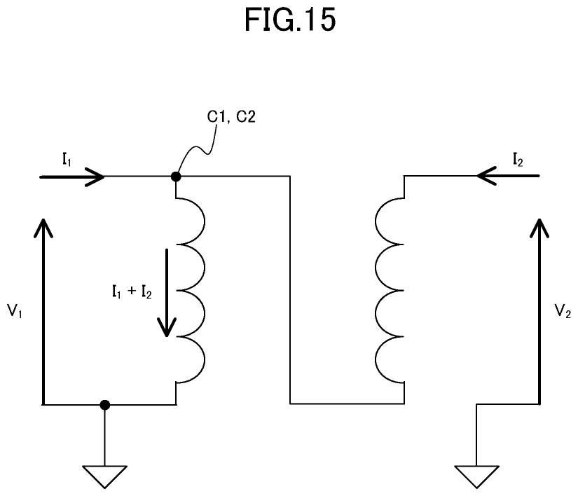

The configuration of the primary and secondary coils is described below. FIG. 12 is an illustration showing the arrangement of conductors. FIGS. 13 and 14 show the connection configurations of the primary and secondary coils, respectively. FIG. 15 is an equivalent circuit diagram of the transformer in the present embodiment.

Each of the six first outer conductors 111 is located at 60° rotated in the circumferential direction from the adjacent first outer conductors 111, when, as shown in FIG. 12, the circle center O of the annular core 13 is considered as the central axis and the center position in the circumferential direction is considered as the reference point. Similarly, each of the six first inner conductors 112, six second outer conductors 121, and six second inner conductors 122 is also located at 60° rotated in the circumferential direction from the adjacent conductors. The six first outer conductors 111 and the six first inner conductors 112 are all located at 30° rotated from each other, and similarly, the six second outer conductors 121 and the six second inner conductors 122 are all located at 30° rotated from each other.

Thus, in the transformer 1, the first outer conductors 111 and the first inner conductors 112 are located at different angular positions in the circumferential direction, and the second outer conductors 121 and the second inner conductors 122 are located at different angular positions in the circumferential direction. Also, the first outer conductors 111 and the second outer conductors 121, or the first inner conductors 112 and the second inner conductors 122 are located at different angular positions in the circumferential direction. As a result, the primary coil L1 and the secondary coil L2 are located at different angular positions in the circumferential direction from each other, in the present embodiment, at angular positions different 30°. In other words, the primary coil L1 and secondary coil L2 are located at angular positions different half of the angle (60°) between two adjacent conductors.

In the case of a transformer configured with coaxial cables, for example, transmission is made in TEM (Transverse ElectroMagnetic) mode, which is uniform with respect to the Poynting vector, but for the transformer 1 in the present embodiment, the electromagnetic field varies depending on the position because of the coil configuration as described above. For the transformer 1 in the present embodiment, the finite element method was used to analyze the arrangement that optimizes the coupling between the primary coil L1 and secondary coil L2, resulting in the arrangement in which the primary coil L1 and secondary coil L2 are offset by 30° in the circumferential direction.

The first outer conductor 111 and the second outer conductor 121 are formed so that the length in the circumferential direction of the first outer conductor 111 and the two second outer conductors 121 adjacent thereto overlap in the radial direction. The first inner conductor 112 and the second inner conductor 122 are also formed so that the length in the circumferential direction of the first inner conductor 112 and the two second inner conductors 122 adjacent thereto overlap in the radial direction. Such configurations can reduce the leakage flux in the coils and thus the leakage inductance of the transformer 1.

As shown in FIG. 13, each of the first inner conductors 112 is connected by the first lower conductors 113 to the first outer conductors 111 located on the clockwise side in the circumferential direction, and by the first upper conductors 153 to the first outer conductors 111 located on the counterclockwise side in the circumferential direction, thus configuring the primary coil L1 that winds around the annular core 13 with the plate-shaped conductors. Similarly, as shown in FIG. 14, each of the second inner conductors 122 is connected by the second lower conductors 123 to the second outer conductors 121 located on the clockwise side in the circumferential direction, and by the second upper conductors 143 to the second outer conductors 121 located on the counterclockwise side in the circumferential direction, thus configuring the secondary coil L2 that winds around the annular core 13 with the plate-shaped conductors.

The ends of primary coil L1 and secondary coil L2 thus configured are electrically connected by the first connecting conductor 128 and the second connecting conductor 123A to form the equivalent circuit shown in FIG. 15. This allows the turns ratio between the primary coil L1 and the secondary coil L2 to be 1:1, compared to the case where the turns ratio would be 1:2 if the primary coil L1 and the secondary coil L2 were insulated, thereby shortening the coil length to improve high frequency properties and reduce conductor loss.

The embodiments of the present invention have been presented by way of example only, and are not intended to limit the scope of the invention. The novel embodiments described herein may be embodied in a variety of other forms; furthermore, various omissions, substitutions and changes may be made without departing from the nature of the invention. The embodiments and modifications are included in the scope or nature of the present invention and in the appended claims and their equivalents.

### REFERENCE SIGNS LIST

1 Transformer
L1 Primary coil
L2 Secondary coil

1. A transformer comprising
an annular core which is a magnetic material formed in a ring shape,
a primary coil configured with plate-shaped conductors wound around the annular core, and
a secondary coil configured with plate-shaped conductors wound around the annular core.

2. The transformer according to claim 1, wherein each of the primary coil and the secondary coil comprises
side conductors that sandwich the annular core from lateral directions perpendicular to a direction of penetration of a hole of the annular core, and
upper and lower conductors that electrically connect the side conductors at both sides in the direction of penetration.

3. The transformer according to claim 2, wherein the side conductors are supported by substrates extending in the lateral directions, and the upper and lower conductors are formed as conductor patterns formed on the substrates.

4. The transformer according to claim 2, wherein the secondary coil is wound around the annular core in such a manner that the secondary coil is positioned closer to the annular core than the primary coil.

5. The transformer according to claim 4, wherein the primary coil and the secondary coil are disposed relative to the annular core in such a manner as to overlap at least partially in the direction of penetration and the lateral directions.

6. The transformer according to claim 1, wherein the primary coil and the secondary coils are electrically connected to each other and have a turns ratio of 1:1.

7. The transformer according to claim 6, wherein the annular core is formed in a circular ring shape, and the secondary coil is positioned offset relative to the primary coil in circumferential direction.

8. The transformer according to claim 3, wherein the secondary coil is wound around the annular core in such a manner that the secondary coil is positioned closer to the annular core than the primary coil.

9. The transformer according to claim 8, wherein the primary coil and the secondary coil are disposed relative to the annular core in such a manner as to overlap at least partially in the direction of penetration and the lateral directions.

10. The transformer according to claim 2, wherein the primary coil and the secondary coil are electrically connected to each other and have a turns ratio of 1:1.

11. The transformer according to claim 10, wherein the annular core is formed in a circular ring shape, and the secondary coil is positioned offset relative to the primary coil in circumferential direction.

12. The transformer according to claim 3, wherein the primary coil and the secondary coil are electrically connected to each other and have a turns ratio of 1:1.

13. The transformer according to claim 12, wherein the annular core is formed in a circular ring shape, and the secondary coil is positioned offset relative to the primary coil in circumferential direction.

14. The transformer according to claim 4, wherein the primary coil and the secondary coil are electrically connected to each other and have a turns ratio of 1:1.

15. The transformer according to claim 14, wherein the annular core is formed in a circular ring shape, and the secondary coil is positioned offset relative to the primary coil in circumferential direction.

16. The transformer according to claim 5, wherein the primary coil and the secondary coil are electrically connected to each other and have a turns ratio of 1:1.

17. The transformer according to claim 16, wherein the annular core is formed in a circular ring shape, and the secondary coil is positioned offset relative to the primary coil in circumferential direction.

18. The transformer according to claim 8, wherein the primary coil and the secondary coil are electrically connected to each other and have a turns ratio of 1:1.

19. The transformer according to claim 18, wherein the annular core is formed in a circular ring shape, and the secondary coil is positioned offset relative to the primary coil in circumferential direction.
